(19) United States
(12) Patent Application Publication
(10) Pub. No.: US 2022/0070964 A1
(43) Pub. Date: Mar. 3, 2022

(54) SIDELINK FEEDBACK IN DISCONTINUOUS RECEPTION MODE OPERATION

(71) Applicant: QUALCOMM Incorporated, San Diego, CA (US)

(72) Inventors: Wei YANG, San Diego, CA (US); Seyedkianoush HOSSEINI, San Diego, CA (US); Yi HUANG, San Diego, CA (US); Hwan Joon KWON, San Diego, CA (US)

(21) Appl. No.: 17/445,765

(22) Filed: Aug. 24, 2021

Related U.S. Application Data
(60) Provisional application No. 63/074,203, filed on Sep. 3, 2020.

(51) Int. Cl. H04W 76/28; H04W 72/12

(52) U.S. Cl. CPC H04W 76/28; H04W 72/1278

(57) ABSTRACT

Various aspects of the present disclosure generally relate to wireless communication. In some aspects, a first user equipment (UE) may determine a discontinuous reception (DRX) mode configuration for a sidelink connection. The first UE may communicate with a second UE using the sidelink connection in accordance with the DRX mode configuration. Numerous other aspects are provided.

### CROSS-REFERENCE TO RELATED APPLICATION

This Patent Application claims priority to U.S. Provisional Patent Application No. 63/074,203, filed on Sep. 3, 2020, entitled “SIDELINK FEEDBACK IN DISCONTINUOUS RECEPTION MODE OPERATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink feedback in discontinuous reception mode operation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some sidelink communications, a user equipment (UE) may use a sensing procedure to determine whether a communication medium (e.g., time resources or frequency resources) is available for communication. A discontinuous reception (DRX) mode may be enabled for sidelink communications to preserve power resources for UEs that are operating in a sidelink network. When a DRX mode is deployed in a sidelink communication system, both a first UE (which may be termed a transmitting (TX) UE) and a second UE (which may be termed a receiving (RX) UE) may operate in respective DRX modes with respective DRX mode configurations. When sensing-based access is configured for sidelink communications, the first UE may not be allowed to transmit if the first UE has not already sensed whether a particular resource is available. Thus, when the first UE receives a physical sidelink control channel (PSCCH), the first UE may not be able to use subsequent resources as a result of not having sensed the subsequent resources before receiving the PSCCH. Moreover, when the respective DRX cycles are not aligned, the first UE and the second UE may not be able to communicate to, for example, enable the second UE to provide hybrid automatic repeat request (HARQ) feedback as a response to a channel state information (CSI) reference signal (RS) (CSI-RS) transmission by the first UE.

In some aspects, a method of wireless communication performed by a first user equipment (UE) includes determining a discontinuous reception (DRX) mode configuration for a sidelink connection; and communicating with a second UE using the sidelink connection in accordance with the DRX mode configuration, wherein a physical sidelink shared channel (PSSCH) and a corresponding physical sidelink feedback channel (PSFCH) are scheduled to occur during a DRX on duration of the second UE.

In some aspects, a method of wireless communication performed by a second UE includes receiving control signaling from a first UE; and communicating with the first UE using a sidelink connection in accordance with a DRX mode configuration of the second UE, wherein a PSSCH and a corresponding PSFCH are scheduled to occur during a DRX on duration of the second UE.

In some aspects, a first UE for wireless communication includes a memory and one or more processors coupled to the memory, the memory and the one or more processors configured to: determine a DRX mode configuration for a sidelink connection; and communicate with a second UE using the sidelink connection in accordance with the DRX mode configuration, wherein a PSSCH and a corresponding PSFCH are scheduled to occur during a DRX on duration of the second UE.

In some aspects, a second UE for wireless communication includes a memory and one or more processors coupled to the memory, the memory and the one or more processors configured to: receive control signaling from a first UE; and communicate with the first UE using a sidelink connection in accordance with a DRX mode configuration of the second UE, wherein a PSSCH and a corresponding PSFCH are scheduled to occur during a DRX on duration of the second UE.

In some aspects, a non-transitory computer-readable medium storing a set of instructions for wireless communication includes one or more instructions that, when executed by one or more processors of a first UE, cause the UE to: determine a DRX mode configuration for a sidelink connection; and communicate with a second UE using the sidelink connection in accordance with the DRX mode configuration, wherein a PSSCH and a corresponding PSFCH are scheduled to occur during a DRX on duration of the second UE.

In some aspects, a non-transitory computer-readable medium storing a set of instructions for wireless communication includes one or more instructions that, when executed by one or more processors of a second UE, cause the UE to: receive control signaling from a first UE; and communicate with the first UE using a sidelink connection in accordance with a DRX mode configuration of the second UE, wherein a PSSCH and a corresponding PSFCH are scheduled to occur during a DRX on duration of the second UE.

In some aspects, a first apparatus for wireless communication includes means for determining a DRX mode configuration for a sidelink connection; and means for communicating with a second apparatus using the sidelink connection in accordance with the DRX mode configuration, wherein a PSSCH and a corresponding PSFCH are scheduled to occur during a DRX on duration of the second UE.

In some aspects, a second apparatus for wireless communication includes means for receiving control signaling from a first apparatus; and means for communicating with the first apparatus using a sidelink connection in accordance with a DRX mode configuration of the second apparatus, wherein a PSSCH and a corresponding PSFCH are scheduled to occur during a DRX on duration of the second UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a discontinuous reception (DRX) configuration in an access network, in accordance with the present disclosure.

FIGS. 6A-6B are diagrams illustrating examples associated with sidelink feedback in DRX mode operation, in accordance with the present disclosure.

FIGS. 7-8 are diagrams illustrating example processes associated with sidelink feedback in DRX mode operation, in accordance with the present disclosure.

FIG. 9 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

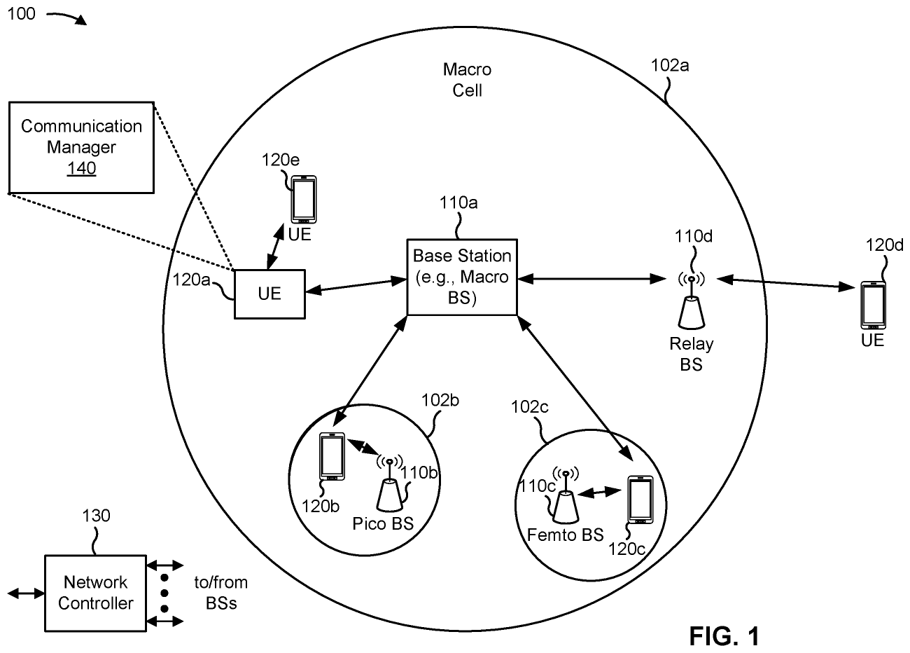

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine a discontinuous reception (DRX) mode configuration for a sidelink connection; and communicate with another UE using the sidelink connection in accordance with the DRX mode configuration, wherein a physical sidelink shared channel (PSSCH) and a corresponding physical sidelink feedback channel (PSFCH) are scheduled to occur during a DRX on duration of the second UE. In some aspects, the communication manager 140 may receive control signaling from a first UE; and communicate with the first UE using a sidelink connection in accordance with a discontinuous reception (DRX) mode configuration of the second UE, wherein a PSSCH and a corresponding PSFCH are scheduled to occur during a DRX on duration of the second UE. Additionally, or alternatively, the communication manager 140 may perform one or more other operations described herein.

As indicated above, FIG. 1 is provided as an example. Other examples may differ from what is described with regard to FIG. 1.

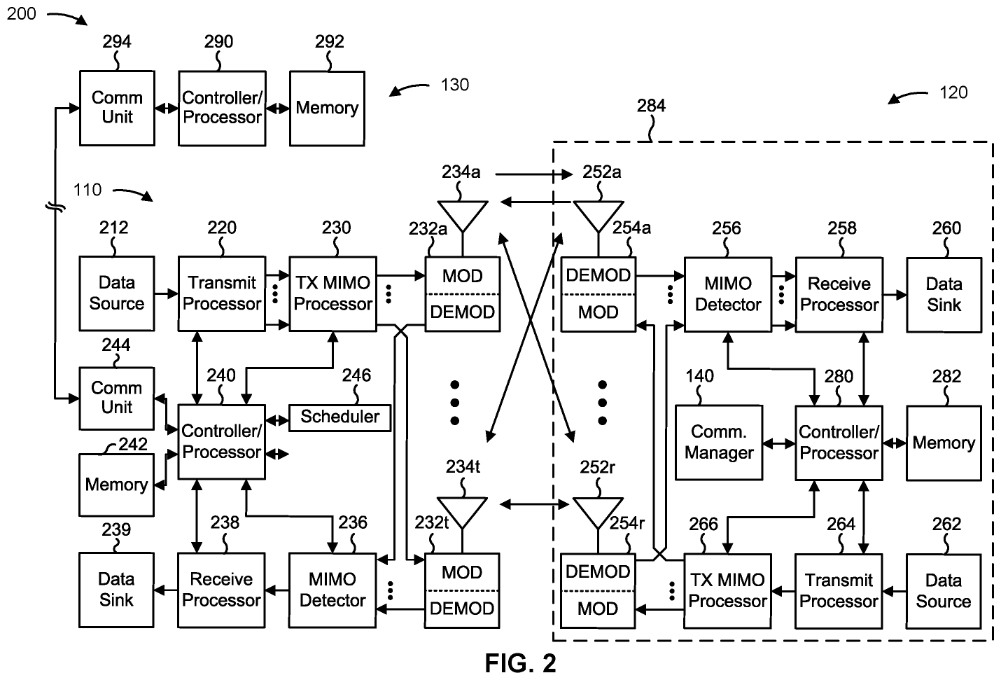

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

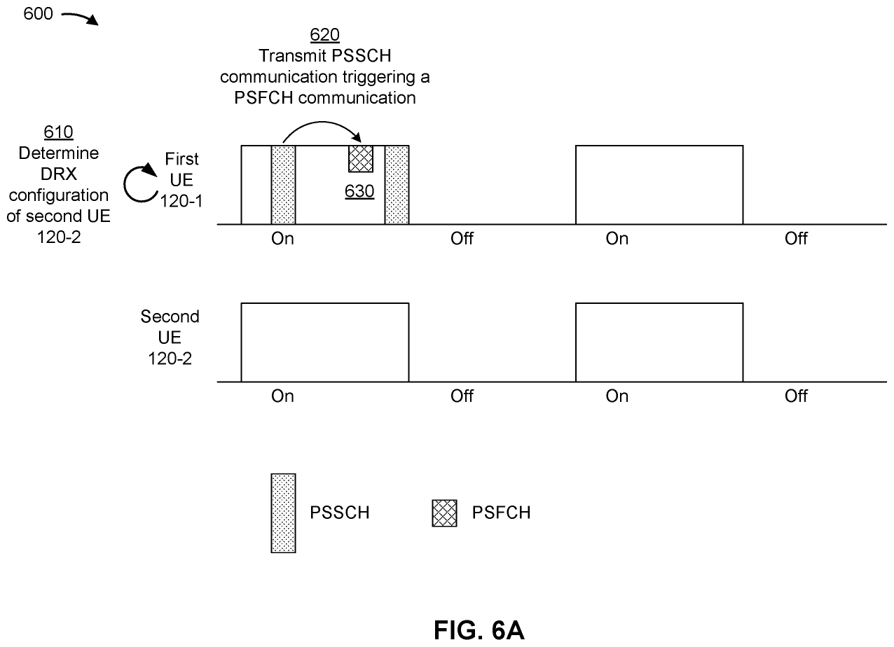

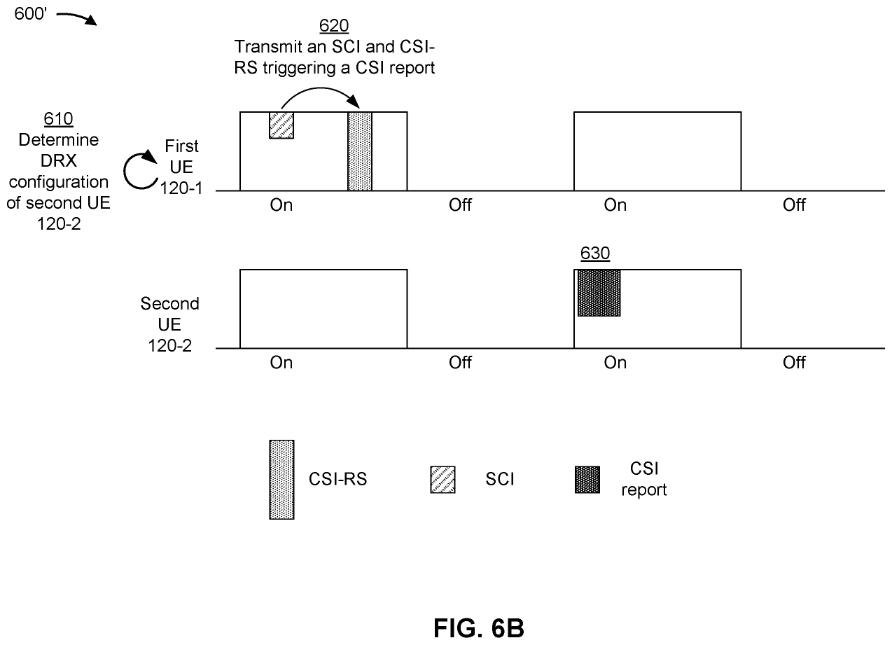

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-9).

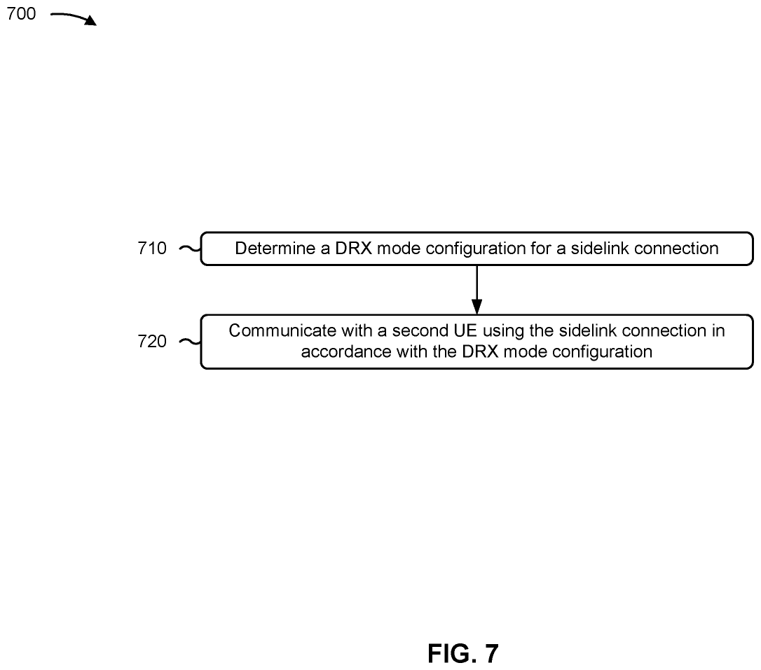

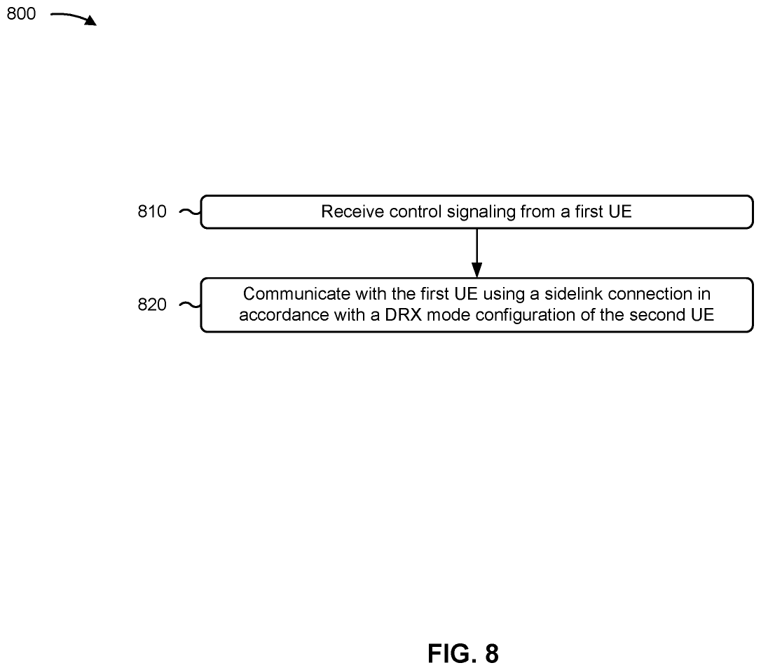

The controller/processor 240 of the base station 110, the controller/processor 280 of the UE 120, and/or any other component(s) of FIG. 2 may perform one or more techniques associated with sidelink feedback in discontinuous reception (DRX) mode operation, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first UE includes means for determining a DRX mode configuration for a sidelink connection; and/or means for communicating with a second UE using the sidelink connection in accordance with the DRX mode configuration, wherein a PSSCH and a corresponding PSFCH are scheduled to occur during a DRX on duration of the second UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the second UE includes means for receiving control signaling from the first UE; and/or means for communicating with the first UE using a sidelink connection in accordance with a DRX mode configuration of the second UE, wherein a PSSCH and a corresponding PSFCH are scheduled to occur during a DRX on duration of the second UE. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

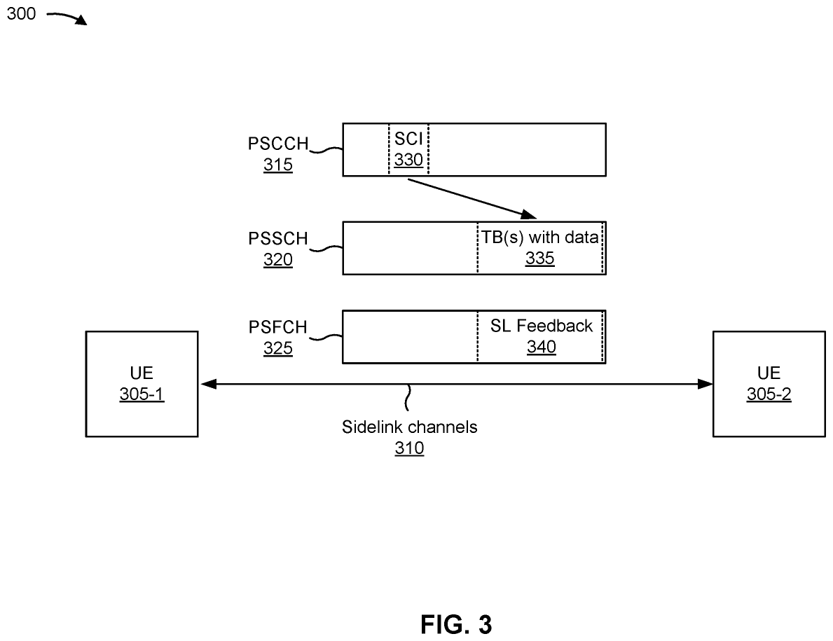

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, vehicle to pedestrian (V2P) communications, and/or the like), mesh networking, and/or the like. The UEs 305 (e.g., UE 305-1 and/or UE 305-2) may correspond to one or more other UEs described elsewhere herein, such as UE 120. The one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), a scheduling request (SR), and/or the like.

The one or more sidelink channels 310 may use resource pools. For example, a scheduling assignment (e.g., included in SCI 330) may be transmitted in sub-channels using specific resource blocks (RBs) across time. Data transmissions (e.g., on the PSSCH 320) associated with a scheduling assignment may occupy adjacent RBs in the same subframe as the scheduling assignment (e.g., using frequency division multiplexing). A scheduling assignment and associated data transmissions are not transmitted on adjacent RBs.

A UE 305 may operate using a transmission mode where resource selection and/or scheduling is performed by the UE 305 (e.g., rather than a base station 110). The UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, a modulation and coding scheme (MCS) to be used for the upcoming sidelink transmission, and/or the like. A UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

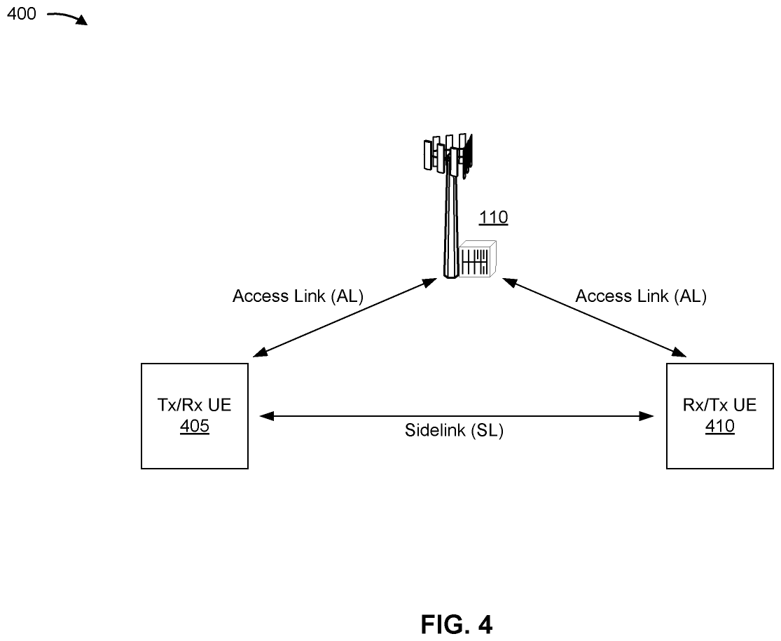

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

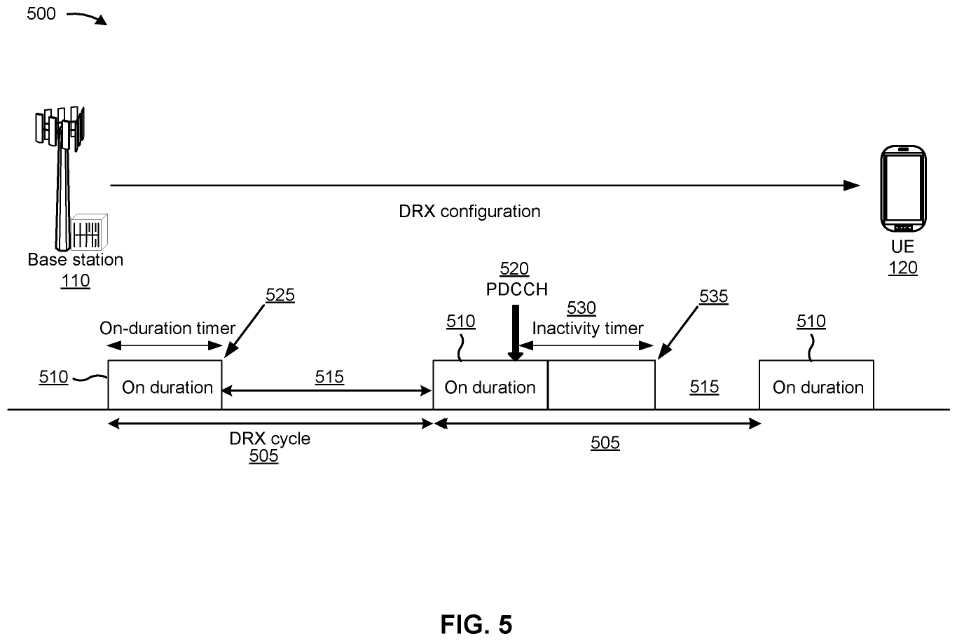

FIG. 5 is a diagram illustrating an example 500 of a discontinuous reception (DRX) configuration in an access network, in accordance with the present disclosure.

As shown in FIG. 5, a base station 110 may transmit a DRX configuration to a UE 120 to configure a DRX cycle 505 for the UE 120. A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a physical downlink control channel (PDCCH) during the active time, and may refrain from monitoring the PDCCH during the inactive time.

During the DRX on duration 510 (e.g., the active time), the UE 120 may monitor a downlink control channel (e.g., a PDCCH), as shown by reference number 520. For example, the UE 120 may monitor the PDCCH for downlink control information (DCI) pertaining to the UE 120. If the UE 120 does not detect and/or successfully decode any PDCCH communications intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX configuration.

However, in sidelink operations, when PSCCH communications, which may correspond to the PDCCH communications described with regard to FIG. 5, are received during DRX on duration 510, UE 120 may not be able to use a subsequent portion of DRX on duration 510 for sidelink communication, as UE 120 may not have performed prior sensing to detect periodic traffic during the subsequent portion of DRX on duration 510. As a result, UE 120 may lack information regarding whether the subsequent portion of DRX on duration 510 is available for sidelink communication.

Returning to FIG. 5, if the UE 120 detects and/or successfully decodes a PDCCH communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot, a subframe, and/or the like). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for PDCCH communications, may obtain a downlink data communication (e.g., on a downlink data channel, such as a physical downlink shared channel (PDSCH)) scheduled by the PDCCH communication, may prepare and/or transmit an uplink communication (e.g., on a physical uplink shared channel (PUSCH)) scheduled by the PDCCH communication, and/or the like. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state 515.

As indicated above, FIG. 5 is provided as an example. Other examples may differ from what is described with respect to FIG. 5.

As described above, some communications systems may enable sidelink communications, such as for relay applications, V2X applications, or V2V applications, among other examples. In some sidelink applications, a UE may use a sensing procedure to determine whether a communication medium (e.g., time resources or frequency resources) is available for communication. A DRX mode may be enabled for sidelink communications to preserve power resources for UEs that are operating in a sidelink network. As described above, in an access link (Uu) network, a BS may configure a DRX mode for a UE. For example, the BS may configure a periodicity of a DRX cycle or a time at which a DRX on duration is to occur, among other examples. In such cases, when the UE receives a PDCCH, the UE may start a DRX inactivity timer and may remain in a DRX on duration until an expiration of the DRX inactivity timer. When operating in a DRX on duration, the UE may report hybrid automatic repeat request (HARQ) feedback (e.g., a HARQ acknowledgement (ACK) or negative acknowledgement (NACK)) to indicate whether the UE successfully received the communication.

When a DRX mode is deployed in a sidelink communication system, both a first UE (which may be termed a transmitting (TX) UE) and a second UE (which may be termed a receiving (RX) UE) may operate in respective DRX modes with respective DRX mode configurations. For example, the first UE and the second UE may have the same or different DRX cycles or the same or different DRX on duration times, among other examples. When sensing-based access is configured for sidelink communications, the first UE may not be allowed to transmit if the first UE has not already sensed whether a particular resource is available. Thus, as described above, when the first UE receives a PSCCH, the first UE may not be able to use subsequent resources as a result of not having sensed the subsequent resources before receiving the PSCCH. Moreover, when the respective DRX cycles are not aligned, the first UE and the second UE may not be able to communicate to, for example, enable the second UE to provide HARQ feedback as a response to a CSI RS transmission by the first UE.

Some aspects described herein enable sidelink feedback in DRX mode operation. For example, a first UE and a second UE may have sidelink DRX cycles associated with sidelink DRX on durations that are configured such that a length of the sidelink DRX cycle is an integer multiple of a length of a physical sidelink shared channel (PSFCH) periodicity and aligned to PSFCH occasions. In this way, the first UE and the second UE ensure that the second UE can transmit HARQ feedback as a response to receiving, for example, a PSSCH from the first UE. Additionally, or alternatively, the first UE may schedule a physical sidelink shared channel (PSSCH) transmission such that the PSSCH transmission and a corresponding PSFCH transmission occur within a DRX on duration of the second UE, thereby enabling the second UE to receive the PSSCH transmission and transmit the corresponding PSFCH transmission.

Additionally, or alternatively, the first UE may transmit a sidelink control information (SCI), which triggers a CSI report, such that a corresponding CSI RS occurs within a DRX on duration of the second UE. Additionally, or alternatively, the second UE may, based at least in part on determining that a gap between a triggered CSI RS and a next DRX on duration is greater than a threshold, be allowed to drop the CSI report. In this way, UEs in a sidelink network may enable sidelink feedback transmission when operating in a DRX mode, thereby enabling power saving from the DRX mode and reliability from using HARQ feedback.

FIGS. 6A and 6B are diagrams illustrating examples 600/600′ of sidelink feedback in DRX mode operation, in accordance with the present disclosure. As shown in FIGS. 6A and 6B, a first UE 120-1 and a second UE 120-2 may communicate with one another, such as in a sidelink network. The terms “first” and “second” may be used to distinguish between UEs 120-1 and 120-2, rather than to denote any order to the UEs 120-1 and 120-2. Moreover, while first UE 120-1 may transmit control signaling to second UE 120-2, as described herein, second UE 120-2 may also transmit control signaling to first UE 120-1 (e.g., at another time, when communicating using another link, etc.).

As further shown in FIGS. 6A and 6B, and by reference number 610, first UE 120-1 may determine a sidelink DRX configuration of second UE 120-2. For example, first UE 120-1 may determine when a sidelink DRX on duration of second UE 120-2 occurs. In some aspects, sidelink DRX configurations, such as a first sidelink DRX configuration of first UE 120-1 or a second sidelink DRX configuration of second UE 120-2, may accord with one or more communication rules. For example, a length of a sidelink DRX cycle and a sidelink DRX on duration may be an integer multiple of a PSFCH periodicity. Additionally, or alternatively, occurrences of the sidelink DRX on duration may be aligned to overlap with PSFCH occasions. For example, a sidelink DRX on duration and an associated sidelink DRX cycle may end with slots that include PSFCH occasions to enable PSFCH transmission in connection with the sidelink DRX on duration.

In some aspects, first UE 120-1 may determine a time at which to transmit a communication. For example, first UE 120-1 may schedule a PSSCH transmission based at least in part on the second sidelink DRX on duration of second UE 120-2. In this case, the PSSCH transmission may correspond to a PSFCH transmission, and first UE 120-1 may schedule the PSSCH transmission such that the corresponding PSFCH transmission also occurs during a sidelink DRX on duration of second UE 120-2. Additionally, or alternatively, when first UE 120-1 and second UE 120-2 have different sidelink DRX on durations, first UE 120-1 may schedule the PSSCH transmission such that the corresponding PSFCH transmission occurs during a first sidelink DRX on duration of first UE 120-1 as well as a second sidelink DRX on duration of the second UE 120-2. In some aspects, the PSFCH may map to the corresponding PSFCH based at least in part on a starting sub-channel of the PSSCH, a slot that includes the PSCCH, a source identifier, or a destination identifier, among other examples.

Additionally, or alternatively, first UE 120-1 may determine a time at which to transmit an SCI and an associated CSI-RS. For example, first UE 120-1 may generate an SCI to schedule a CSI-RS during a DRX on duration of second UE 120-2 and, in some aspects, at a time where there is a feedback resource in a sidelink DRX on duration of second UE 120-2 for second UE 120-2 to transmit a CSI report as a response to the CSI-RS.

As further shown in FIGS. 6A and 6B, and by reference number 620, first UE 120-1 may transmit a first communication to second UE 120-2 in accordance with the DRX configuration of second UE 120-2. For example, first UE 120-1 may transmit a PSSCH transmission that triggers a PSFCH transmission (e.g., of HARQ feedback). Additionally, or alternatively, first UE 120-1 may transmit an SCI and/or a CSI-RS that triggers a CSI report. In some aspects, first UE 120-1 may transmit the first communication during a sidelink DRX on duration of second UE 120-2 and at a time when there is a sidelink feedback resource available to second UE 120-2 during a sidelink DRX on duration of second UE 120-2.

As further shown in FIGS. 6A and 6B, and by reference number 630, first UE 120-1 and second UE 120-2 may communicate on a sidelink feedback channel based at least in part on the transmission of the first communication. For example, second UE 120-2 may transmit a PSFCH communication, such as a HARQ ACK or a HARQ NACK, using a sidelink feedback resource during an on duration of second UE 120-2. Additionally, or alternatively, second UE 120-2 may transmit a CSI report generated based at least in part on a CSI-RS. In this case, second UE 120-2 may transmit the CSI report during a sidelink DRX on duration of second UE 120-2. In some aspects, second UE 120-2 may determine that a sidelink feedback resource does not occur during a sidelink DRX on duration of second UE 120-2 within a threshold period of time of the CSI report being triggered. In this case, second UE 120-2 may drop the CSI report to avoid excessively queuing the CSI report for transmission.

As indicated above, FIGS. 6A and 6B are provided as examples. Other examples may differ from what is described with respect to FIGS. 6A and 6B.

FIG. 7 is a diagram illustrating an example process 700 performed, for example, by a first UE, in accordance with the present disclosure. Example process 700 is an example where the UE (e.g., UE 120) performs operations associated with sidelink feedback in DRX mode operation.

As shown in FIG. 7, in some aspects, process 700 may include determining a DRX mode configuration for a sidelink connection (block 710). For example, the UE (e.g., using determination component 908, depicted in FIG. 908) may determine a DRX mode configuration for a sidelink connection, as described above.

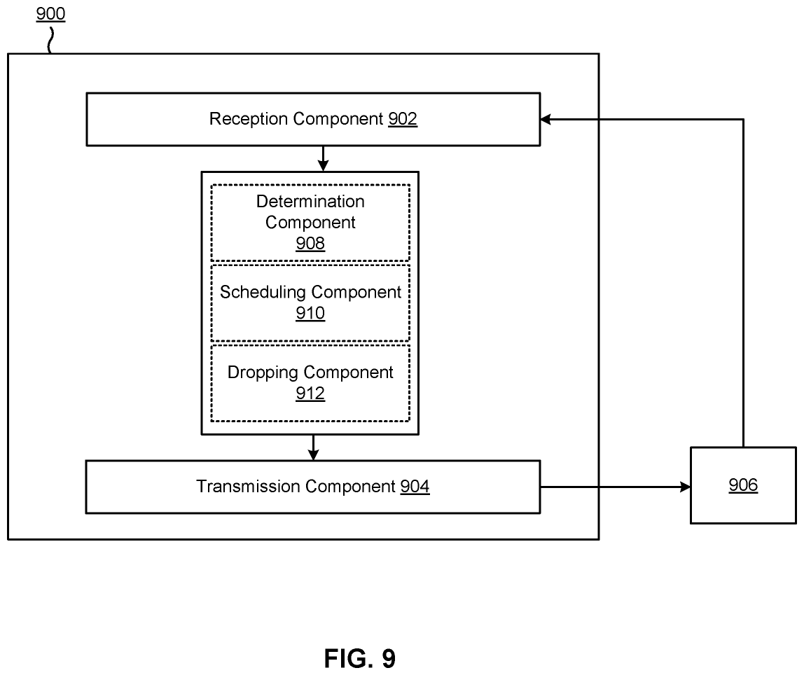

As further shown in FIG. 7, in some aspects, process 700 may include communicating with a second UE using the sidelink connection in accordance with the DRX mode configuration (block 720). For example, the UE (e.g., using reception component 902 or transmission component 904, depicted in FIG. 9) may communicate with a second UE using the sidelink connection in accordance with the DRX mode configuration, as described above. In some aspects, a PSSCH and a corresponding PSFCH are scheduled to occur during a DRX on duration of the second UE.

Process 700 may include additional aspects, such as any single aspect or any combination of aspects described below and/or in connection with one or more other processes described elsewhere herein.

In a first aspect, a first length of a DRX cycle and a DRX on duration for the sidelink connection is an integer multiple of a second length of a PSFCH periodicity, and wherein communicating with the second UE comprises receiving a HARQ feedback message on the sidelink connection during a DRX on duration and using a PSFCH resource.

In a second aspect, alone or in combination with the first aspect, the DRX on duration and the DRX cycle end in a slot that includes a PSFCH occasion, wherein the PSFCH occasion includes the PSFCH resource.

In a third aspect, alone or in combination with one or more of the first and second aspects, process 700 includes scheduling a physical sidelink shared channel (PSSCH) transmission to the second UE, wherein the PSSCH transmission and an associated PSFCH transmission are scheduled to occur during a DRX on duration of the second UE, and wherein communicating with the second UE comprises transmitting the PSSCH transmission to the second UE during the DRX on duration of the second UE, and receiving the associated PSFCH transmission from the second UE during the DRX on duration of the second UE.

In a fourth aspect, alone or in combination with one or more of the first through third aspects, the associated PSFCH transmission is scheduled to occur during a DRX on duration of the first UE.

In a fifth aspect, alone or in combination with one or more of the first through fourth aspects, communicating with the second UE comprises transmitting a sidelink control information (SCI), wherein a channel state information (CSI) report triggered by the SCI is scheduled for a resource within an on duration of the second UE, and receiving the CSI report triggered by the SCI during the on duration of the second UE.

In a sixth aspect, alone or in combination with one or more of the first through fifth aspects, communicating with the second UE comprises transmitting a CSI reference signal (RS) during the on duration of the second UE to enable generation of the CSI report.

In a seventh aspect, alone or in combination with one or more of the first through sixth aspects, communicating with the second UE comprises transmitting an SCI that triggers a CSI report, wherein a gap between the SCI and the CSI report is greater than a threshold, and forgoing receipt of the CSI report based at least in part on the gap between the SCI and the CSI report being greater than the threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second UE, in accordance with the present disclosure. Example process 800 is an example where the UE (e.g., UE 120) performs operations associated with sidelink feedback in DRX mode operation.

As shown in FIG. 8, in some aspects, process 800 may include receiving control signaling from a first UE (block 810). For example, the UE (e.g., using reception component 902, depicted in FIG. 9) may receive control signaling from a first UE, as described above.

As further shown in FIG. 8, in some aspects, process 800 may include communicating with the first UE using a sidelink connection in accordance with a DRX mode configuration of the second UE (block 820). For example, the UE (e.g., using reception component 902 or transmission component 904, depicted in FIG. 9) may communicate with the first UE using a sidelink connection in accordance with a DRX mode configuration of the second UE, as described above. In some aspects, a PSSCH and a corresponding PSFCH are scheduled to occur during a DRX on duration of the second UE.

Process 800 may include additional aspects, such as any single aspect or any combination of aspects described below and/or in connection with one or more other processes described elsewhere herein.

In a first aspect, a first length of a DRX cycle and a DRX on duration for the sidelink connection is an integer multiple of a second length of a PSFCH periodicity, and wherein communicating with the first UE comprises transmitting a HARQ feedback message on the sidelink connection during a DRX on duration and using a PSFCH resource.

In a second aspect, alone or in combination with the first aspect, the DRX on duration and the DRX cycle end in a slot that includes a PSFCH occasion, wherein the PSFCH occasion includes the PSFCH resource.

In a third aspect, alone or in combination with one or more of the first and second aspects, process 800 includes receiving information identifying a scheduling of a PSSCH transmission by the first UE, wherein the PSSCH transmission and an associated PSFCH transmission are scheduled to occur during a DRX on duration of the second UE, and wherein communicating with the first UE comprises receiving the PSSCH transmission from the first UE during the DRX on duration of the second UE, and transmitting the associated PSFCH transmission to the first UE during the DRX on duration of the second UE.

In a fourth aspect, alone or in combination with one or more of the first through third aspects, the associated PSFCH transmission is scheduled to occur during a DRX on duration of the first UE.

In a fifth aspect, alone or in combination with one or more of the first through fourth aspects, communicating with the first UE comprises receiving an SCI, wherein a CSI report triggered by the SCI is scheduled for a resource within an on duration of the second UE, and transmitting the CSI report triggered by the SCI during the on duration of the second UE.

In a sixth aspect, alone or in combination with one or more of the first through fifth aspects, communicating with the first UE comprises receiving a CSI RS during the on duration of the second UE, and generating the CSI report based at least in part on receiving the CSI RS.

In a seventh aspect, alone or in combination with one or more of the first through sixth aspects, communicating with the first UE comprises receiving an SCI that triggers a CSI report, wherein a gap between the SCI and the CSI report is greater than a threshold, and dropping transmission of the CSI report based at least in part on the gap between the SCI and the CSI report being greater than the threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include one or more of a determination component 908, a scheduling component 910, or a dropping component 912, among other examples.

In some aspects, the apparatus 900 may be configured to perform one or more operations described herein in connection with FIGS. 6A-6B. Additionally or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be collocated with the reception component 902 in a transceiver. The reception component 902 or the transmission component 904, among others, may communicate with another apparatus using the sidelink connection in accordance with the DRX mode configuration.

The determination component 908 may determine a DRX mode configuration for a sidelink connection. In some aspects, the determination component 908 may include a receive processor, a transmit processor, a controller/processor, a memory, or a combination thereof, of the UE described above in connection with FIG. 2.

The scheduling component 910 may schedule a communication with another apparatus. In some aspects, the scheduling component 910 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The dropping component 912 may drop transmission or reception of a triggered communication, such as a CSI report. In some aspects, the dropping component 912 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first user equipment (UE), comprising: determining a discontinuous reception (DRX) mode configuration for a sidelink connection; and communicating with a second UE using the sidelink connection in accordance with the DRX mode configuration, wherein a physical sidelink shared channel (PSSCH) and a corresponding physical sidelink feedback channel (PSFCH) are scheduled to occur during a DRX on duration of the second UE.

Aspect 2: The method of Aspect 1, wherein first lengths of a DRX cycle for the sidelink connection and a DRX on duration of the first UE are integer multiples of a second length of a PSFCH periodicity; and wherein communicating with the second UE comprises: receiving a hybrid automatic repeat request (HARQ) feedback message on the sidelink connection during the DRX on duration of the second UE and using a PSFCH resource.

Aspect 3: The method of Aspect 2, wherein the DRX on duration of the first UE and the DRX cycle end in a slot that includes a PSFCH occasion, wherein the PSFCH occasion includes the PSFCH resource.

Aspect 4: The method of any of Aspects 1 to 3, further comprising: scheduling a PSSCH transmission to the second UE, wherein the PSSCH transmission and an associated PSFCH transmission are scheduled to occur during the DRX on duration of the second UE; and wherein communicating with the second UE comprises: transmitting the PSSCH transmission to the second UE during the DRX on duration of the second UE; and receiving the associated PSFCH transmission from the second UE during the DRX on duration of the second UE.

Aspect 5: The method of Aspect 4, wherein the associated PSFCH transmission is scheduled to occur during a DRX on duration of the first UE.

Aspect 6: The method of any of Aspects 1 to 5, wherein communicating with the second UE comprises: transmitting a sidelink control information (SCI), wherein a channel state information (CSI) report triggered by the SCI is scheduled for a resource within the on duration of the second UE; and receiving the CSI report triggered by the SCI during the on duration of the second UE.

Aspect 7: The method of Aspect 6, wherein communicating with the second UE comprises: transmitting a CSI reference signal (RS) during the on duration of the second UE to enable generation of the CSI report.

Aspect 8: The method of any of Aspects 1 to 7, wherein communicating with the second UE comprises: transmitting a sidelink control information (SCI) that triggers a channel state information (CSI) report, wherein a gap between the SCI and the CSI report is greater than a threshold; and forgoing receipt of the CSI report based at least in part on the gap between the SCI and the CSI report being greater than the threshold.

Aspect 9: A method of wireless communication performed by a second user equipment (UE), comprising: receiving control signaling from a first UE; and communicating with the first UE using a sidelink connection in accordance with a discontinuous reception (DRX) mode configuration of the second UE, wherein a physical sidelink shared channel (PSSCH) and a corresponding physical sidelink feedback channel (PSFCH) are scheduled to occur during a DRX on duration of the second UE.

Aspect 10: The method of Aspect 9, wherein first lengths of a DRX cycle for the sidelink connection and a DRX on duration for the first UE are integer multiples of a second length of a PSFCH periodicity; and wherein communicating with the first UE comprises: transmitting a hybrid automatic repeat request (HARQ) feedback message on the sidelink connection during a DRX on duration and using a PSFCH resource.

Aspect 11: The method of Aspect 10, wherein the DRX on duration of the first UE and the DRX cycle end in a slot that includes a PSFCH occasion, wherein the PSFCH occasion includes the PSFCH resource.

Aspect 12: The method of any of Aspects 9 to 11, further comprising: receiving information identifying a scheduling of a PSSCH transmission by the first UE, wherein the PSSCH transmission and an associated PSFCH transmission are scheduled to occur during the DRX on duration of the second UE; and wherein communicating with the first UE comprises: receiving the PSSCH transmission from the first UE during the DRX on duration of the second UE; and transmitting the associated PSFCH transmission to the first UE during the DRX on duration of the second UE.

Aspect 13: The method of Aspect 12, wherein the associated PSFCH transmission is scheduled to occur during a DRX on duration of the first UE.

Aspect 14: The method of any of Aspects 9 to 13, wherein communicating with the first UE comprises: receiving a sidelink control information (SCI), wherein a channel state information (CSI) report triggered by the SCI is scheduled for a resource within the on duration of the second UE; and transmitting the CSI report triggered by the SCI during the on duration of the second UE.

Aspect 15: The method of Aspect 14, wherein communicating with the first UE comprises: receiving a CSI reference signal (RS) during the on duration of the second UE; and generating the CSI report based at least in part on receiving the CSI RS.

Aspect 16: The method of any of Aspects 9 to 15, wherein communicating with the first UE comprises: receiving a sidelink control information (SCI) that triggers a channel state information (CSI) report, determining that a gap between the SCI and the CSI report is greater than a threshold; and dropping transmission of the CSI report based at least in part on the gap between the SCI and the CSI report being greater than the threshold.

Aspect 17: An apparatus for wireless communication at a device, comprising a processor; memory coupled with the processor; and instructions stored in the memory and executable by the processor to cause the apparatus to perform the method of one or more of Aspects 1-8.

Aspect 18: A device for wireless communication, comprising a memory and one or more processors coupled to the memory, the one or more processors configured to perform the method of one or more of Aspects 1-8.

Aspect 19: An apparatus for wireless communication, comprising at least one means for performing the method of one or more of Aspects 1-8.

Aspect 20: A non-transitory computer-readable medium storing code for wireless communication, the code comprising instructions executable by a processor to perform the method of one or more of Aspects 1-8.

Aspect 21: A non-transitory computer-readable medium storing a set of instructions for wireless communication, the set of instructions comprising one or more instructions that, when executed by one or more processors of a device, cause the device to perform the method of one or more of Aspects 1-8.

Aspect 22: An apparatus for wireless communication at a device, comprising a processor; memory coupled with the processor; and instructions stored in the memory and executable by the processor to cause the apparatus to perform the method of one or more of Aspects 9-16.

Aspect 23: A device for wireless communication, comprising a memory and one or more processors coupled to the memory, the one or more processors configured to perform the method of one or more of Aspects 9-16.

Aspect 24: An apparatus for wireless communication, comprising at least one means for performing the method of one or more of Aspects 9-16.

Aspect 25: A non-transitory computer-readable medium storing code for wireless communication, the code comprising instructions executable by a processor to perform the method of one or more of Aspects 9-16.

Aspect 26: A non-transitory computer-readable medium storing a set of instructions for wireless communication, the set of instructions comprising one or more instructions that, when executed by one or more processors of a device, cause the device to perform the method of one or more of Aspects 9-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a first user equipment (UE), comprising:
determining a discontinuous reception (DRX) mode configuration for a sidelink connection; and
communicating with a second UE using the sidelink connection in accordance with the DRX mode configuration, wherein a physical sidelink shared channel (PSSCH) and a corresponding physical sidelink feedback channel (PSFCH) are scheduled to occur during a DRX on duration of the second UE.

2. The method of claim 1, wherein first lengths of a DRX cycle for the sidelink connection and a DRX on duration of the first UE are integer multiples of a second length of a PSFCH periodicity; and
wherein communicating with the second UE comprises:
receiving a hybrid automatic repeat request (HARQ) feedback message on the sidelink connection during the DRX on duration of the second UE and using a PSFCH resource.

3. The method of claim 2, wherein the DRX on duration of the first UE and the DRX cycle end in a slot that includes a PSFCH occasion, wherein the PSFCH occasion includes the PSFCH resource.

4. The method of claim 1, further comprising:
scheduling a PSSCH transmission to the second UE, wherein the PSSCH transmission and an associated PSFCH transmission are scheduled to occur during the DRX on duration of the second UE; and
wherein communicating with the second UE comprises:
transmitting the PSSCH transmission to the second UE during the DRX on duration of the second UE; and
receiving the associated PSFCH transmission from the second UE during the DRX on duration of the second UE.

5. The method of claim 4, wherein the associated PSFCH transmission is scheduled to occur during a DRX on duration of the first UE.

6. The method of claim 1, wherein communicating with the second UE comprises:
transmitting a sidelink control information (SCI), wherein a channel state information (CSI) report triggered by the SCI is scheduled for a resource within the on duration of the second UE; and
receiving the CSI report triggered by the SCI during the on duration of the second UE.

7. The method of claim 6, wherein communicating with the second UE comprises:
transmitting a CSI reference signal (RS) during the on duration of the second UE to enable generation of the CSI report.

8. The method of claim 1, wherein communicating with the second UE comprises:
transmitting a sidelink control information (SCI) that triggers a channel state information (CSI) report, wherein a gap between the SCI and the CSI report is greater than a threshold; and
forgoing receipt of the CSI report based at least in part on the gap between the SCI and the CSI report being greater than the threshold.

9. A method of wireless communication performed by a second user equipment (UE), comprising:
receiving control signaling from a first UE; and
communicating with the first UE using a sidelink connection in accordance with a discontinuous reception (DRX) mode configuration of the second UE, wherein a physical sidelink shared channel (PSSCH) and a corresponding physical sidelink feedback channel (PSFCH) are scheduled to occur during a DRX on duration of the second UE.

10. The method of claim 9, wherein first lengths of a DRX cycle for the sidelink connection and a DRX on duration for the first UE are integer multiples of a second length of a PSFCH periodicity; and
wherein communicating with the first UE comprises:
transmitting a hybrid automatic repeat request (HARQ) feedback message on the sidelink connection during a DRX on duration and using a PSFCH resource.

11. The method of claim 10, wherein the DRX on duration of the first UE and the DRX cycle end in a slot that includes a PSFCH occasion, wherein the PSFCH occasion includes the PSFCH resource.

12. The method of claim 9, further comprising:
receiving information identifying a scheduling of a PSSCH transmission by the first UE, wherein the PSSCH transmission and an associated PSFCH transmission are scheduled to occur during the DRX on duration of the second UE; and
wherein communicating with the first UE comprises:
receiving the PSSCH transmission from the first UE during the DRX on duration of the second UE; and
transmitting the associated PSFCH transmission to the first UE during the DRX on duration of the second UE.

13. The method of claim 12, wherein the associated PSFCH transmission is scheduled to occur during a DRX on duration of the first UE.

14. The method of claim 9, wherein communicating with the first UE comprises:
receiving a sidelink control information (SCI), wherein a channel state information (CSI) report triggered by the SCI is scheduled for a resource within the on duration of the second UE; and
transmitting the CSI report triggered by the SCI during the on duration of the second UE.

15. The method of claim 14, wherein communicating with the first UE comprises:
receiving a CSI reference signal (RS) during the on duration of the second UE; and
generating the CSI report based at least in part on receiving the CSI RS.

16. The method of claim 9, wherein communicating with the first UE comprises:
receiving a sidelink control information (SCI) that triggers a channel state information (CSI) report,
determining that a gap between the SCI and the CSI report is greater than a threshold; and
dropping transmission of the CSI report based at least in part on the gap between the SCI and the CSI report being greater than the threshold.

17. A first user equipment (UE) for wireless communication, comprising:
a memory; and
one or more processors, coupled to the memory, configured to:
determine a discontinuous reception (DRX) mode configuration for a sidelink connection; and
communicate with a second UE using the sidelink connection in accordance with the DRX mode configuration, wherein a physical sidelink shared channel (PSSCH) and a corresponding physical sidelink feedback channel (PSFCH) are scheduled to occur during a DRX on duration of the second UE.

18. The UE of claim 17, wherein first lengths of a DRX cycle for the sidelink connection and a DRX on duration of the first UE are integer multiples of a second length of a PSFCH periodicity; and
wherein the one or more processors, to communicate with the second UE, are configured to:
receive a hybrid automatic repeat request (HARQ) feedback message on the sidelink connection during the DRX on duration of the second UE and using a PSFCH resource.

19. The UE of claim 18, wherein the DRX on duration of the first UE and the DRX cycle end in a slot that includes a PSFCH occasion, wherein the PSFCH occasion includes the PSFCH resource.

20. The UE of claim 17, wherein the one or more processors are further configured to:
schedule a PSSCH transmission to the second UE, wherein the PSSCH transmission and an associated PSFCH transmission are scheduled to occur during the DRX on duration of the second UE; and
wherein the one or more processors, to communicate with the second UE, are configured to:
transmit the PSSCH transmission to the second UE during the DRX on duration of the second UE; and
receive the associated PSFCH transmission from the second UE during the DRX on duration of the second UE.

21. The UE of claim 20, wherein the associated PSFCH transmission is scheduled to occur during a DRX on duration of the first UE.

22. The UE of claim 17, wherein the one or more processors, to communicate with the second UE, are configured to:
transmit a sidelink control information (SCI), wherein a channel state information (CSI) report triggered by the SCI is scheduled for a resource within the on duration of the second UE; and
receive the CSI report triggered by the SCI during the on duration of the second UE.

23. The UE of claim 22, wherein the one or more processors, to communicate with the second UE, are configured to:
transmit a CSI reference signal (RS) during the on duration of the second UE to enable generation of the CSI report.

24. The UE of claim 17, wherein the one or more processors, to communicate with the second UE, are configured to:
transmit a sidelink control information (SCI) that triggers a channel state information (CSI) report, wherein a gap between the SCI and the CSI report is greater than a threshold; and
forgo receipt of the CSI report based at least in part on the gap between the SCI and the CSI report being greater than the threshold.

25. A second user equipment (UE) for wireless communication, comprising:
a memory; and
one or more processors, coupled to the memory, configured to:
receive control signaling from a first UE; and
communicate with the first UE using a sidelink connection in accordance with a discontinuous reception (DRX) mode configuration of the second UE, wherein a physical sidelink shared channel (PSSCH) and a corresponding physical sidelink feedback channel (PSFCH) are scheduled to occur during a DRX on duration of the second UE.

26. The UE of claim 25, wherein first lengths of a DRX cycle for the sidelink connection and a DRX on duration for the first UE are integer multiples of a second length of a PSFCH periodicity; and
wherein the one or more processors, to communicate with the first UE, are configured to:
transmit a hybrid automatic repeat request (HARQ) feedback message on the sidelink connection during a DRX on duration and using a PSFCH resource.

27. The UE of claim 26, wherein the DRX on duration of the first UE and the DRX cycle end in a slot that includes a PSFCH occasion, wherein the PSFCH occasion includes the PSFCH resource.

28. The UE of claim 25, wherein the one or more processors are further configured to:
receive information identifying a scheduling of a PSSCH transmission by the first UE, wherein the PSSCH transmission and an associated PSFCH transmission are scheduled to occur during the DRX on duration of the second UE; and
wherein the one or more processors, to communicate with the first UE, are configured to:
receive the PSSCH transmission from the first UE during the DRX on duration of the second UE; and
transmit the associated PSFCH transmission to the first UE during the DRX on duration of the second UE.

29. The UE of claim 28, wherein the associated PSFCH transmission is scheduled to occur during a DRX on duration of the first UE.

30. The UE of claim 25, wherein the one or more processors, to communicate with the first UE, are configured to:
receive a sidelink control information (SCI), wherein a channel state information (CSI) report triggered by the SCI is scheduled for a resource within the on duration of the second UE; and
transmit the CSI report triggered by the SCI during the on duration of the second UE.
